(19) United States
(12) Patent Application Publication
(10) Pub. No.: US 2023/0191513 A1
(43) Pub. Date: Jun. 22, 2023

(54) TOOL DIAGNOSTIC DEVICE

(71) Applicant: FANUC CORPORATION, Yamanashi (JP)

(72) Inventor: Yasuhiro SHIBASAKI, Yamanashi (JP)

(21) Appl. No.: 17/999,560

(22) PCT Filed: May 19, 2021
(86) PCT No.: PCT/JP2021/018959

§ 371 Date: Nov. 22, 2022

(30) Foreign Application Priority Data
May 25, 2020 (JP) 2020-090818

(51) Int. Cl. B23G 1/44; G01M 13/00

(52) U.S. Cl. CPC B23G 1/44; G01M 13/00; B23G 2240/52

(57) ABSTRACT

A tool diagnostic device includes a data acquisition unit configured to acquire, as waveform data, a state quantity of a motor for driving a tool before and after rotation of the tool stops in tapping, a reference waveform generation unit configured to generate reference waveform data, a difference waveform calculation unit configured to calculate, as difference waveform data, a difference between waveform data and the reference waveform data, a waveform feature calculation unit configured to calculate waveform feature data indicating a feature of a waveform from the difference waveform data, a learning result storage unit configured to store a learning result of learning a correlation between waveform feature data and a tool life, and a state diagnostic unit configured to diagnose a state of the tool based on the waveform feature data using a learning result.

### TECHNICAL FIELD

The present invention relates to a tool diagnostic device, and particularly to a diagnostic device for diagnosing a state of a tool used for tapping.

### BACKGROUND ART

An edge of a tool used in a machine tool wears with passage of time used for machining, and the edge is damaged. As a result, cutting resistance increases and machining accuracy deteriorates. Further, it will be impossible to maintain predetermined machining accuracy required for a workpiece. In general, this point is determined to be an end of a life by assuming that the tool deteriorates to the extent that the tool cannot be used.

When the life of the tool ends, if machining is continued without tool replacement, the quality of the manufactured workpiece deteriorates. Therefore, the tool is replaced. Conventionally, the number of times the tool can be operated is determined in advance according to the design specifications of the tool, and the tool is replaced when the number of times the tool has been operated reaches the number of times the tool can be operated.

In this case, the actual operating conditions and individual differences of the tool itself are not reflected in the timing of tool replacement, so that the original life cannot be fully utilized.

As a conventional technique for determining a state of a tool based on a state quantity that can be obtained from the tool itself, there is a method of imaging a cutting tool using an image pickup means and diagnosing a state of the tool based on this image data (for example, Patent Document 1 etc.).

Further, as a conventional technique for determining a state of a tool using a state quantity acquired at the time of machining, there is a method of acquiring a load of a spindle motor for driving the tool and electric power related to driving as a state quantity, and diagnosing the state of the tool from a waveform of the obtained load or electric power (for example, Patent Documents 2 and 3, etc.).

CITATION LIST

### Patent Document

Patent Document 1: JP 2011-045988 A

Patent Document 2: JP 2013-248717 A

Patent Document 3: JP H09-300176 A

### SUMMARY OF THE INVENTION

### Problem to be Solved by the Invention

When a new sensor is added to an industrial machine, costs increase. Therefore, there is a demand for diagnosing a state of a tool using a state quantity that can be measured with a basic configuration without adding a new sensor. As the state quantity that can be measured with the basic configuration, data such as a current/voltage value, a position, and a speed that can be acquired from the motor may be considered. However, the data such as the current/voltage, the position, and the speed acquired from the motor include data acquired when machining is performed under various machining conditions. In addition, noise caused by machining situations and environment is included in the data. Therefore, even when a time-series data waveform is simply analyzed, it is not easy to understand how an influence of tool deterioration appears. In addition, even when a rule base is built based on experience and is used to diagnose a state of a tool, it is difficult to deal with a lot of situations. Therefore, it may not be possible to perform machining with high accuracy.

Therefore, there is a demand for a method capable of accurately diagnosing a state of a tool based on a state quantity acquired from a machine.

### Means for Solving Problem

A tool diagnostic device collects servo data at the time of machining by tapping of similar design specifications, pays attention to an acceleration/deceleration section before and after rotation stop, and learns a degree of change with respect to a reference waveform. Then, the above problem is solved by diagnosing a state of a tool based on an inference result for a waveform to be diagnosed using a learning result.

An aspect of the invention is a tool diagnostic device for diagnosing a state of a tool used in an industrial machine for performing tapping, the tool diagnostic device including a data acquisition unit configured to acquire, as waveform data, a state quantity of a motor for driving the tool before and after rotation of the tool stops in the tapping, a reference waveform generation unit configured to generate reference waveform data based on waveform data acquired during first machining by the tool, a difference waveform calculation unit configured to calculate, as difference waveform data, a difference between waveform data acquired by the data acquisition unit and the reference waveform data, a waveform feature calculation unit configured to calculate waveform feature data indicating a feature of a waveform from the difference waveform data, a learning result storage unit configured to store a learning result of learning a correlation between waveform feature data and a time for next tool replacement, and a state diagnostic unit configured to diagnose a state of the tool based on the waveform feature data using a learning result stored in the learning result storage unit, in which the waveform feature calculation unit calculates waveform feature data from data in a section of at least one of a deceleration part before rotation of the motor stops and an acceleration part after rotation of the motor stops in the difference waveform data.

### Effect of the Invention

According to an aspect of the invention, learning may be performed based on data that can be acquired from an industrial machine during machining, and a state of a tool may be accurately diagnosed based on a learning result. Therefore, the number of tool replacements may be reduced without incurring a large cost, and production efficiency may be improved.

### BRIEF DESCRIPTION OF DRAWINGS

FIG. 1 is a schematic hardware configuration diagram of a diagnostic device according to a first embodiment;

FIG. 2 is a schematic block diagram illustrating functions of the diagnostic device according to the first embodiment;

FIG. 3 is a diagram illustrating an example of waveform data;

FIG. 4 is a diagram comparing reference waveform data with waveform data;

FIG. 5 is a diagram illustrating an example of difference waveform data;

FIG. 6 is a diagram for describing data used for learning;

FIG. 7 is a schematic hardware configuration diagram of a diagnostic device according to a second embodiment; and

FIG. 8 is a schematic block diagram illustrating functions of the diagnostic device according to the second embodiment.

### MODE(S) FOR CARRYING OUT THE INVENTION

Hereinafter, embodiments of the invention will be described with reference to the drawings.

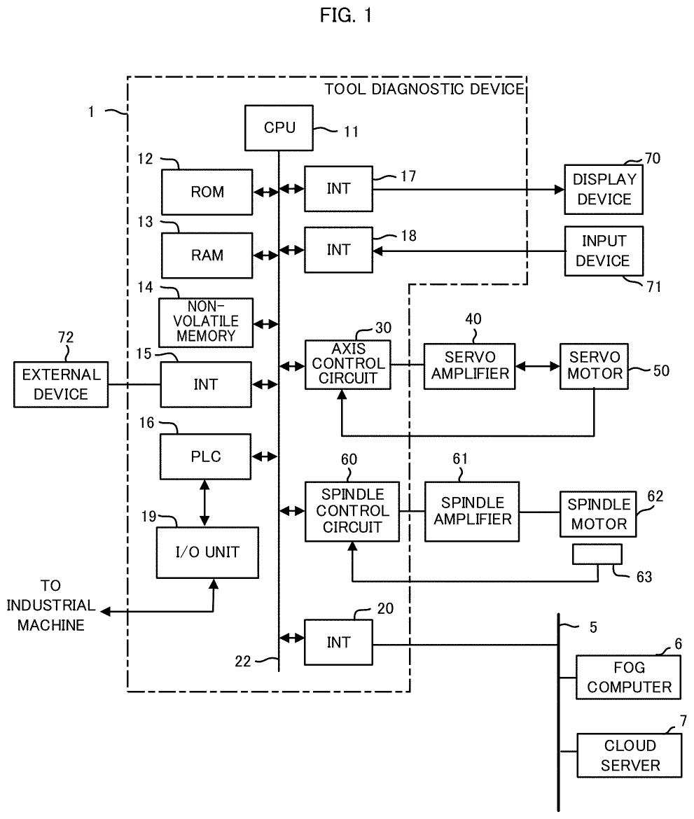

FIG. 1 is a schematic hardware configuration diagram illustrating a tool diagnostic device according to a first embodiment. For example, a tool diagnostic device 1 may be implemented in a controller that controls an industrial machine for performing tapping based on a control program. Further, the tool diagnostic device 1 may be implemented in a personal computer installed side by side with the controller that controls the industrial machine based on the control program, or a personal computer, a cell computer, a fog computer, or a cloud server connected to the controller via a wired/wireless network. The present embodiment illustrates an example in which the tool diagnostic device 1 is implemented in the controller that controls the industrial machine based on the control program.

A CPU 11 included in the tool diagnostic device 1 according to the present embodiment is a processor that controls the tool diagnostic device 1 as a whole. The CPU 11 reads a system program stored in a ROM 12 via a bus 22. The CPU 11 controls the entire tool diagnostic device 1 according to the read system program. Temporary calculation data, display data, various data input from the outside, etc. are temporarily stored in a RAM 13.

A non-volatile memory 14 includes, for example, a memory backed up by a battery (not illustrated), an SSD (Solid State Drive), etc. The non-volatile memory 14 retains a storage state thereof even when power of the tool diagnostic device 1 is turned off. The non-volatile memory 14 stores control programs and data read from an external device 72 via an interface 15. Further, the non-volatile memory 14 stores control programs and data input via an input device 71. Further, the non-volatile memory 14 stores control programs, data, etc. acquired from other devices via a network 5. The control programs or data stored in the non-volatile memory 14 may be loaded in the RAM 13 at the time of execution/use. Further, various system programs such as known analysis programs are written in the ROM 12 in advance.

The interface 15 is an interface for connecting the CPU 11 of the tool diagnostic device 1 and the external device 72 such as a USB device to each other. From the external device 72 side, for example, a control program, setting data, etc. used for controlling the industrial machine are read. Further, the control program, the setting data, etc. edited in the tool diagnostic device 1 may be stored in an external storage means via the external device 72. A PLC (programmable logic controller) 16 executes a ladder program, outputs a signal to the industrial machine and a peripheral device of the industrial machine (for example, a tool replacement device, an actuator such as a robot, or a sensor such as a temperature sensor or a humidity sensor attached to the industrial machine) via an I/O unit 19, and performs a control operation. Further, the PLC 16 receives signals from various switches of an operation panel installed in a main body of the industrial machine and peripheral devices, performs necessary signal processing, and then passes the signals to the CPU 11.

An interface 20 is an interface for connecting the CPU 11 of the tool diagnostic device 1 and the wired or wireless network 5 to each other. Other industrial machines, a fog computer 6, a cloud server 7, etc. are connected to the network 5 to mutually exchange data with the tool diagnostic device 1.

Each piece of data read on a memory, data obtained as a result of executing a program, etc. are output to and displayed on a display device 70 via an interface 17. Further, the input device 71 including a keyboard, a pointing device, etc. passes commands, data, etc. based on an operation by an operator to the CPU 11 via an interface 18.

An axis control circuit 30 for controlling an axis included in the industrial machine receives an axis movement command amount from the CPU 11 and outputs an axis command to a servo amplifier 40. In response to this command, the servo amplifier 40 drives a servo motor 50 that moves a drive unit included in the industrial machine along the axis. The servo motor 50 of the axis has a built-in position/speed detector, and feeds back a position/speed feedback signal from the position/speed detector to the axis control circuit 30. As a result, position/speed feedback control is performed. Note that in the hardware configuration diagram of FIG. 1, only one axis control circuit 30, one servo amplifier 40, and one servo motor 50 are illustrated. However, in practice, each of the numbers of axis control circuit 30, servo amplifiers 40, and servo motors 50 prepared is the same as the number of axes included in the industrial machine to be controlled. For example, when a general machine tool is controlled, three sets of axis control circuit 30, servo amplifiers 40, and servo motors 50 are prepared to relatively move a spindle having a tool attached in directions of three straight axes (X-axis, Y-axis, and Z-axis) with respect to a workpiece.

A spindle control circuit 60 receives a spindle rotation command and outputs a spindle speed signal to a spindle amplifier 61. In response to receiving this spindle speed signal, the spindle amplifier 61 rotates a spindle motor 62 of the industrial machine at a commanded rotation speed to drive the tool. A position coder 63 is coupled to the spindle motor 62. The position coder 63 outputs a feedback pulse in synchronization with rotation of the spindle, and the feedback pulse is read by the CPU 11.

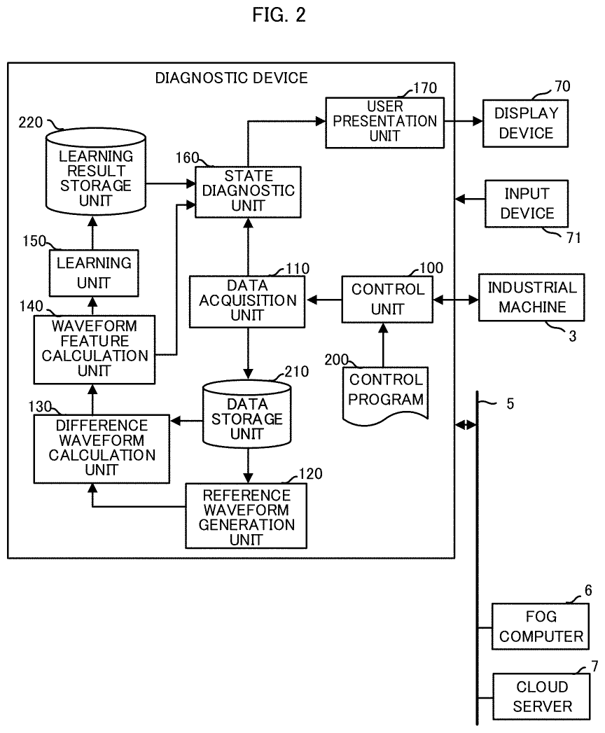

FIG. 2 illustrates functions included in the tool diagnostic device 1 according to the first embodiment as a schematic block diagram. Each function of the tool diagnostic device 1 according to the present embodiment is implemented by the CPU 11 included in the tool diagnostic device 1 illustrated in FIG. 1 executing a system program and controlling an operation of each unit of the tool diagnostic device 1.

The tool diagnostic device 1 includes a control unit 100, a data acquisition unit 110, a difference waveform calculation unit 130, a waveform feature calculation unit 140, a learning unit 150, and a state diagnostic unit 160. Further, the RAM 13 or the non-volatile memory 14 of the tool diagnostic device 1 store a control program 200 for controlling an industrial machine 3. Further, the RAM 13 or the non-volatile memory 14 of the tool diagnostic device 1 is provided with a data storage unit 210, which is an area for storing waveform data generated from a value of a torque command, etc. of the spindle motor 62 acquired in time series during machining by the industrial machine 3. In addition, the RAM 13 or the non-volatile memory 14 of the tool diagnostic device 1 is provided with a learning result storage unit 220, which is an area for storing a learning model created by the learning unit 150.

The control unit 100 is implemented by the CPU 11 executing a system program read from the ROM 12 and performing arithmetic processing using the RAM 13 and the non-volatile memory 14 mainly by the CPU 11, control processing of each unit of the industrial machine using the axis control circuit 30, the spindle control circuit 60, and the PLC 16, and input/output processing via the interface 18. The control unit 100 analyzes the control program 200 and creates command data for controlling the industrial machine 3 including the servo motor 50 and the spindle motor 62 and peripheral devices of the industrial machine 3. Then, the control unit 100 controls each unit of the industrial machine 3 and the peripheral devices based on the created command data. For example, the control unit 100 generates data related to movement of an axis based on a command for moving the drive unit along each axis of the industrial machine 3, and outputs the data to the servo motor 50. Further, for example, the control unit 100 generates data related to rotation of the spindle based on a command for rotating the spindle of the industrial machine 3 and outputs the data to the spindle motor 62. Furthermore, for example, the control unit 100 generates a predetermined signal for operating a peripheral device of the industrial machine 3 based on a command for operating the peripheral device, and outputs the signal to the PLC 16. Meanwhile, the control unit 100 acquires a state of the servo motor 50 or the spindle motor 62 (current value, position, speed, acceleration, torque command, etc. of a motor) as a feedback value and uses the state for each control process.

The data acquisition unit 110 is implemented by the CPU 11 executing a system program read from the ROM 12 and performing arithmetic processing mainly by the CPU 11 using the RAM 13 and the non-volatile memory 14. The data acquisition unit 110 acquires a data value related to the motor when the industrial machine 3 performs tapping as waveform data, and stores the data value in the data storage unit 210. The data acquisition unit 110 mainly acquires a value of a torque command before and after rotation stop of the spindle when the industrial machine 3 performs tapping.

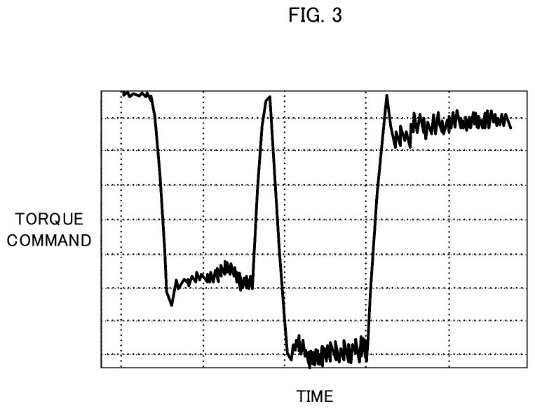

More specifically, waveform data of a torque command is acquired while the tool attached to the spindle to rotate is inserted into a pilot hole provided in the workpiece to perform machining, the spindle stops at a bottom of the hole, and the tool is removed from the workpiece by rotating in a reverse direction. FIG. 3 is a diagram illustrating an example of waveform data of a torque command acquired by the data acquisition unit 110. The data acquisition unit 110 may associate information such as an identification number that can identify the tool being used, a tool type (model number), machining conditions (spindle rotation speed, feed rate, time constant, workpiece material, etc.), a date and time when the waveform data is acquired, and a cumulative machining count after the tool is first used with the acquired waveform data of the torque command, and store the information.

The reference waveform generation unit 120 is implemented by the CPU 11 executing a system program read from the ROM 12 and performing arithmetic processing mainly by the CPU 11 using the RAM 13 and the non-volatile memory 14. The reference waveform generation unit 120 generates reference waveform data serving as a reference for diagnosing deterioration of the tool based on data stored in the data storage unit 210 and acquired in the past machining. The reference waveform generation unit 120 generates reference waveform data based on time-series data acquired when machining is performed by a new tool in data stored in the data storage unit 210. For example, the time-series data acquired when machining is performed by the new tool may be determined based on a cumulative machining count (the time-series data acquired when machining is performed by the new tool has a cumulative machining count of 1), etc. The reference waveform generation unit 120 generates reference waveform data for each tool.

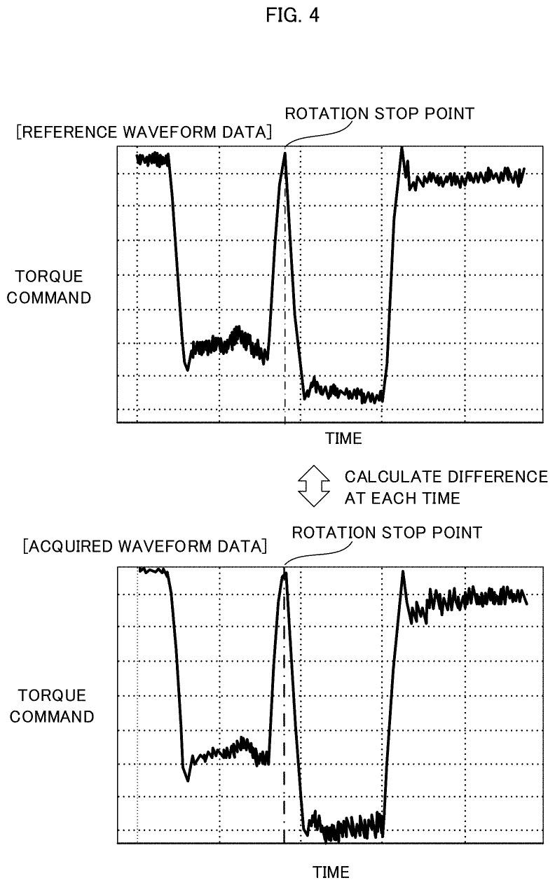

The difference waveform calculation unit 130 is implemented by the CPU 11 executing a system program read from the ROM 12 and performing arithmetic processing mainly by the CPU 11 using the RAM 13 and the non-volatile memory 14. The difference waveform calculation unit 130 calculates difference waveform data between waveform data acquired when machining is performed by the tool and reference waveform data acquired when machining is performed using the same tool and under the same machining condition. As illustrated in FIG. 4, the difference waveform calculation unit 130 calculates difference waveform data by matching a position of a rotation stop point in the reference waveform data with a position of a rotation stop point of the acquired waveform data and then calculating a difference in data value at each time.

The waveform feature calculation unit 140 is implemented by the CPU 11 executing a system program read from the ROM 12 and performing arithmetic processing mainly by the CPU 11 using the RAM 13 and the non-volatile memory 14. The waveform feature calculation unit 140 calculates data S1 indicating a waveform feature from difference waveform data calculated by the difference waveform calculation unit 130. In the present embodiment, as a section in which the waveform feature data S1 indicating the waveform feature is calculated, attention is paid particularly to an acceleration/deceleration section of the spindle before and after the rotation stop point.

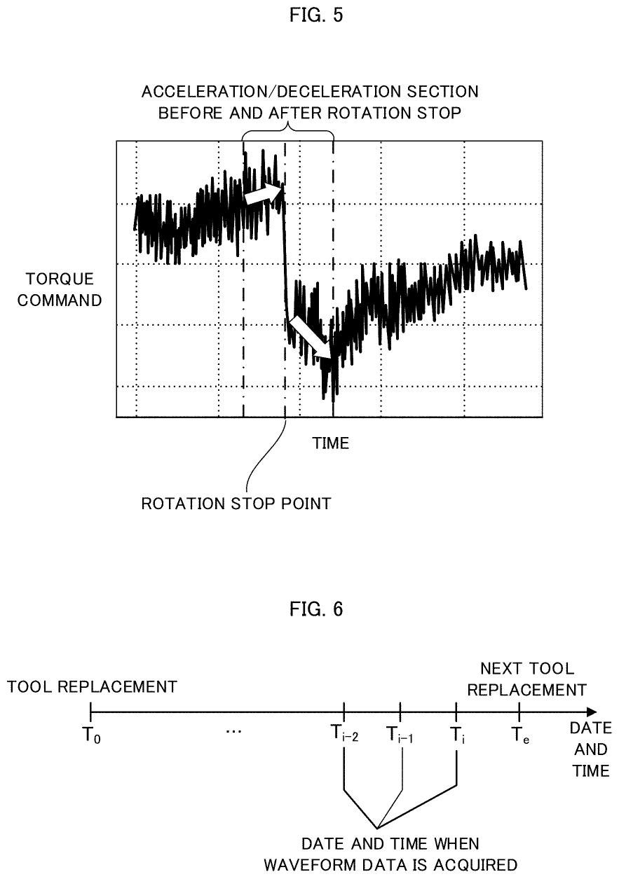

FIG. 5 is an example of the difference waveform data calculated by the difference waveform calculation unit 130. The example of FIG. 5 illustrates difference waveform data in which the spindle rotates forward during tapping to machine the workpiece, rotation of the spindle stops, and then the spindle reverses and retracts from the workpiece. Here, the applicant has found that, in the acceleration/deceleration section before and after the spindle stops rotating, when the tool is new, there is no inclination in a change tendency of the difference waveform, and as the tool wear progresses, a particularly large inclination occurs as indicated by a white arrow in FIG. 5. Therefore, the waveform feature calculation unit 140 extracts data of this part as the waveform feature data S1 indicating the features of the waveform. Specifically, the waveform feature calculation unit 140 executes a smoothing process on the difference waveform data to calculate a change tendency of the difference waveform. Then, the waveform feature calculation unit 140 extracts data of two or more predetermined points in a deceleration section before rotation stop or an acceleration section after rotation stop, and uses this data as the waveform feature data S1. The waveform feature calculation unit 140 may extract data of two or more predetermined points from both the deceleration section before the rotation stop and the acceleration section after the rotation stop, and use the data as the waveform feature data S1.

The learning unit 150 is implemented by the CPU 11 executing a system program read from the ROM 12 and performing arithmetic processing mainly by the CPU 11 using the RAM 13 and the non-volatile memory 14. The learning unit 150 performs learning related to the state of the tool based on the waveform feature data S1 calculated by the waveform feature calculation unit 140. As illustrated in FIG. 6, for example, the learning unit 150 performs learning based on the waveform feature data S1 calculated from waveform data acquired between a date and time T₀ when tool replacement is performed and a date and time Tₑ when next tool replacement is performed. The learning unit 150 learns a correlation between each piece of the waveform feature data S1 and a difference between a date and time when the waveform data from which the waveform feature data S1 is calculated is acquired and the date and time Tₑ when the next tool replacement is performed.

The learning unit 150 may learn a correlation between the waveform feature data S1 and a time until the next tool replacement using a method of creating a predetermined correlation function. When the method of creating the correlation function is used, a template of the correlation function may be created in advance. In this case, a correlation function that matches a relationship between the waveform feature data S1 and the time until the next tool replacement is created for each tool type and machining condition based on the template, and is stored in the learning result storage unit 220 as a learning result. The correlation function may be created for each tool type and machining condition. Further, it is possible to create one correlation function in which the tool type or the machining condition is included as a variable.

The learning unit 150 may learn the correlation between the waveform feature data S1 and the time until the next tool replacement using a rule-based inference method that creates a predetermined rule. When the rule-based inference method is used, a template of a rule group may be created in advance, and a rule group, which matches the relationship between the waveform feature data S1 and the time until the next tool replacement, may be created for each tool type and machining condition based on the template and stored in the learning result storage unit 220 as a learning result. The rule group may be created for each tool type and machining condition. In addition, it is possible to create a rule group in which the tool type or the machining condition is included in a condition for determining a rule.

The learning unit 150 may learn the correlation between the waveform feature data S1 and the time until the next tool replacement by a supervised learning method using a neural network, an SVM (Support Vector Machine), etc. When the supervised learning method is used, teacher data T, in which the waveform feature data S1 is set as input data S and the time until the next tool replacement is set as label data L, is created. Then, using the teacher data T, a learning model having learned the correlation between the input data S and the label data L may be created and stored in the learning result storage unit 220 as a learning result. The learning model may be created for each tool type and machining condition. In addition, tool data S2 indicating the tool type and machining condition data S3 indicating a machining condition may be included in the input data S to create one learning model having learned a correlation between this data and the label data L.

In addition, the learning unit 150 may appropriately use other methods for learning correlation, such as learning by a fuzzy reasoning method and learning by clustering.

The state diagnostic unit 160 is implemented by the CPU 11 executing a system program read from the ROM 12 and performing arithmetic processing mainly by the CPU 11 using the RAM 13 and the non-volatile memory 14. The state diagnostic unit 160 diagnoses a time (that is, life) at which a tool currently in use needs to be replaced with a next tool based on a waveform feature calculated by the waveform feature calculation unit 140 based on waveform data acquired during machining using a learning result stored in the learning result storage unit 220. For example, when the learning unit 150 creates a correlation function as a learning result, the state diagnostic unit 160 reads a correlation function matching a type of tool currently in use and a machining condition from the learning result storage unit 220. The state diagnostic unit 160 inputs a waveform feature of waveform data currently acquired for the read correlation function and calculates a time until next tool replacement. For example, when the learning unit 150 creates a rule group as a learning result, the state diagnostic unit 160 reads a rule group matching a type of tool currently in use and a machining condition from the learning result storage unit 220. The state diagnostic unit 160 applies a waveform feature of waveform data currently acquired to the read rule group, and sets a conclusion derived therefrom as a time until next tool replacement. For example, when the learning unit 150 creates a learning model for supervised learning as a learning result, the state diagnostic unit 160 reads a learning model matching a type of tool currently in use and a machining condition from the learning result storage unit 220. The state diagnostic unit 160 inputs a waveform feature of waveform data currently acquired to the read learning model and estimates a time until next tool replacement. A time, at which next tool replacement needs to be performed, diagnosed by the state diagnostic unit 160 is output to a user presentation unit 170.

The user presentation unit 170 is implemented by the CPU 11 executing a system program read from the ROM 12 and performing arithmetic processing mainly by the CPU 11 using the RAM 13 and the non-volatile memory 14 and output processing using the interface 17. The user presentation unit 170 displays the time, at which next tool replacement needs to be performed, diagnosed by the state diagnostic unit 160 on the display device 70, thereby presenting the time at which next tool replacement needs to be performed to a user. When the time, at which next tool replacement needs to be performed, diagnosed by the state diagnostic unit 160 is smaller than a predetermined threshold value, the user presentation unit 170 may display a predetermined warning display and an alarm as well as the time at which next tool replacement needs to be performed.

The tool diagnostic device 1 having the above configuration operates in at least two modes. In a first mode (learning mode), the tool diagnostic device 1 performs learning by the learning unit 150. In this mode, waveform data is acquired and stored in the data storage unit 210 each time a workpiece is machined using a predetermined tool and under a predetermined machining condition. Then, when the tool is replaced by the operator, the reference waveform generation unit 120 generates reference waveform data from waveform data acquired when the tool is attached and machining is performed for the first time. Then, the learning unit 150 learns a relationship between a plurality of pieces of waveform data acquired while continuing machining using the tool, and the tool type and machining condition. A learning result is stored in the learning result storage unit 220.

When the learning result is stored in the learning result storage unit 220, the tool diagnostic device 1 can operate in a second mode (diagnosis mode). In the second mode (diagnosis mode), the tool diagnostic device diagnoses a state of the tool by the state diagnostic unit 160. The tool diagnostic device 1 acquires waveform data each time a workpiece is machined using a predetermined tool and under a predetermined machining condition, and diagnoses a tool state using a learning result stored in the learning result storage unit 220 based on the acquired data. A diagnosis result of the tool state, that is, a time until next tool replacement is performed is displayed on the display device 70. While viewing this display, the operator can determine when to interrupt machining and replace the tool.

When learning is performed in the first mode (learning mode), it is desirable that a skilled operator determines a timing of tool replacement. By using a learning result created by learning based on data obtained in this way, the state diagnostic unit 160 can diagnose a time until immediately before a tool currently in use becomes unusable as a time at which next tool replacement needs to be performed.

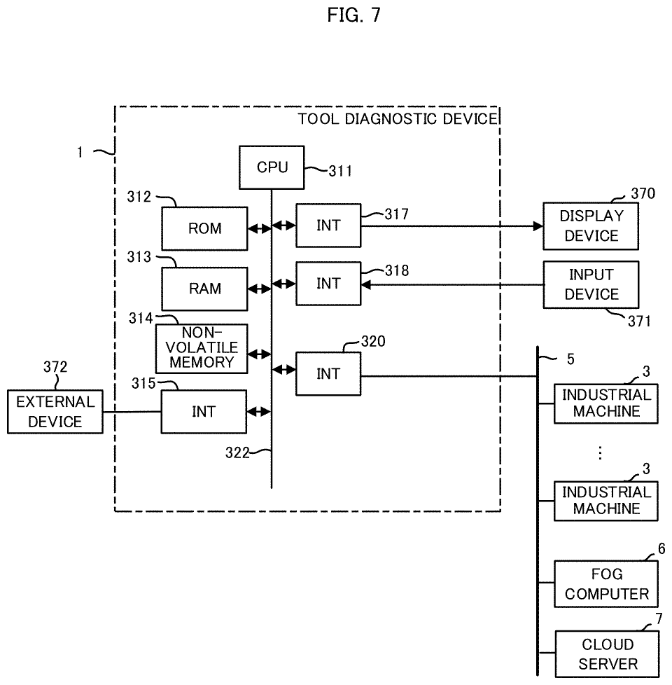

FIG. 7 is a schematic hardware configuration diagram illustrating a tool diagnostic device 1 of a second embodiment. The present embodiment illustrates an example in which the tool diagnostic device 1 is implemented in a computer such as a personal computer, a cell computer, a fog computer, or a cloud server connected to a plurality of industrial machines (including a controller) via a wired/wireless network.

A CPU 311 included in the tool diagnostic device 1 according to the present embodiment is a processor that controls the tool diagnostic device 1 as a whole. The CPU 311 reads a system program stored in a ROM 312 via a bus 322, and controls the entire tool diagnostic device 1 according to the system program. Temporary calculation data, display data, various data input from the outside, etc. are temporarily stored in a RAM 313.

A non-volatile memory 314 includes, for example, a memory backed up by a battery (not illustrated), an SSD (Solid State Drive), etc. The non-volatile memory 314 retains a storage state even when power of the tool diagnostic device 1 is turned off. The non-volatile memory 314 stores data read from an external device 372 via an interface 315 and data input via an input device 371. Further, the non-volatile memory 314 stores data, etc. acquired from a plurality of industrial machines 3 and other computers via a network 5. The control program or data stored in the non-volatile memory 314 may be loaded in the RAM 313 at the time of execution/use. Further, various system programs such as known analysis programs are written to the ROM 312 in advance.

The interface 315 is an interface for connecting the CPU 311 of the tool diagnostic device 1 and the external device 372 such as a USB device to each other. Data, etc. are read from the external device 372. Further, data, etc. edited in the tool diagnostic device 1 can be stored in an external storage means via the external device 372.

An interface 320 is an interface for connecting the CPU 311 of the tool diagnostic device 1 and the wired or wireless network 5 to each other. The plurality of industrial machines 3, a fog computer 6, a cloud server 7, etc. are connected to the network 5 to mutually exchange data with the tool diagnostic device 1.

Each piece of data read on a memory, data obtained as a result of executing a program, etc. are output to and displayed on a display device 370 via an interface 317. Further, the input device 371 including a keyboard, a pointing device, etc. passes commands, data, etc. based on an operation by an operator to the CPU 311 via an interface 318.

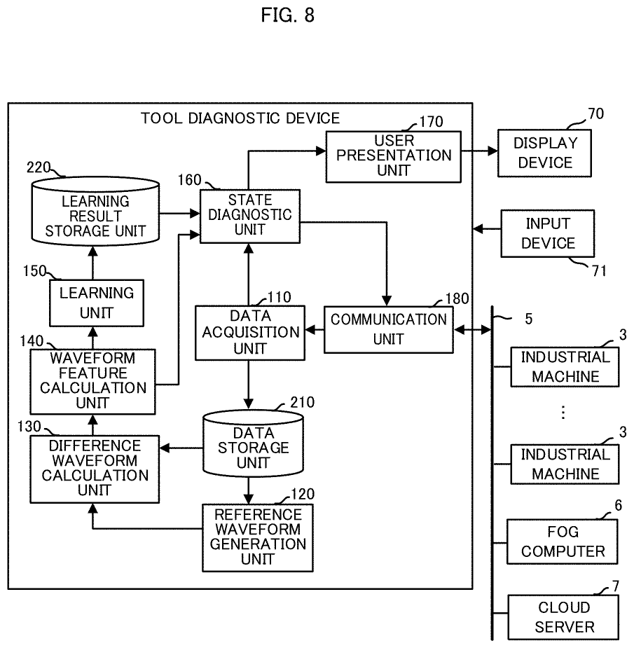

FIG. 8 illustrates functions included in the tool diagnostic device 1 according to the second embodiment as a schematic block diagram. Each function included in the tool diagnostic device 1 according to the present embodiment is implemented by the CPU 311 included in the tool diagnostic device 1 illustrated in FIG. 7 executing a system program and controlling an operation of each unit of the tool diagnostic device 1.

The tool diagnostic device 1 of the present embodiment includes a data acquisition unit 110, a difference waveform calculation unit 130, a waveform feature calculation unit 140, a learning unit 150, a state diagnostic unit 160, and a communication unit 180. Further, a data storage unit 210, which is an area for storing waveform data generated from a value of a torque command, etc. of a spindle motor 362 acquired in time series during machining by the industrial machine 3, is provided in the RAM 313 or the non-volatile memory 314 of the tool diagnostic device 1. In addition, a learning result storage unit 220, which is an area for storing a learning model created by the learning unit 150, is provided in the RAM 313 or the non-volatile memory 314.

The data acquisition unit 110, the difference waveform calculation unit 130, the waveform feature calculation unit 140, the learning unit 150, and the state diagnostic unit 160 included in the tool diagnostic device 1 according to the present embodiment have functions similar to those of respective units included in the tool diagnostic device 1 according to the first embodiment, except that processing is performed based on waveform data acquired from the plurality of industrial machines 3.

The communication unit 180 is implemented by the CPU 311 included in the tool diagnostic device 1 illustrated in FIG. 7 executing a system program read from the ROM 312 and performing arithmetic processing using the RAM 313 and the non-volatile memory 314 mainly by the CPU 311, and communication processing using the interface 320. The communication unit 180 receives waveform data detected during machining from the plurality of industrial machines 3. Further, the communication unit 180 transmits a result of diagnosing a time, at which next tool replacement needs to be performed for a tool currently in use in each industrial machine 3, diagnosed by the state diagnostic unit 160 to the industrial machine 3.

The tool diagnostic device 1 performs learning based on waveform data acquired from the plurality of industrial machines 3. Since data used for learning using each tool or under each machining condition can be collected from the plurality of industrial machines 3, efficient learning can be performed. Further, since it is possible to diagnose a time at which next tool replacement of the tool needs to be performed in the plurality of industrial machines 3, the overall cost can be suppressed when compared to the case where the tool diagnostic device 1 is implemented in the controller of each industrial machine 3.

Even though one embodiment of the invention has been described above, the invention is not limited only to examples of the above-described embodiment, and can be implemented in various modes by making appropriate changes.

In the above-described embodiment, an example in which the torque command is mainly used as the waveform data used for learning/diagnosis is illustrated. However, as the waveform data used for learning/diagnosis, for example, it is possible to use a speed command value, or to use a feedback value of a speed or torque.

### EXPLANATIONS OF LETTERS OR NUMERALS

1 TOOL DIAGNOSTIC DEVICE

3 INDUSTRIAL MACHINE

5 NETWORK

6 FOG COMPUTER

7 CLOUD SERVER

11, 311 CPU

12, 312 ROM

13, 313 RAM

14, 314 NON-VOLATILE MEMORY

15, 17, 18, 20, 21, 315, 317, 318, 320 INTERFACE

16 PLC

19 I/O UNIT

22, 322 BUS

30 AXIS CONTROL CIRCUIT

40 SERVO AMPLIFIER

50 SERVO MOTOR

70 DISPLAY DEVICE

71 INPUT DEVICE

72 EXTERNAL DEVICE

100 CONTROL UNIT

110 DATA ACQUISITION UNIT

120 REFERENCE WAVEFORM GENERATION UNIT

130 DIFFERENCE WAVEFORM CALCULATION UNIT

140 WAVEFORM FEATURE CALCULATION UNIT

150 LEARNING UNIT

160 STATE DIAGNOSTIC UNIT

170 USER PRESENTATION UNIT

180 COMMUNICATION UNIT

200 CONTROL PROGRAM

210 DATA STORAGE UNIT

220 LEARNING RESULT STORAGE UNIT

1. A tool diagnostic device for diagnosing a state of a tool used in an industrial machine for performing tapping, the tool diagnostic device comprising:
a data acquisition unit configured to acquire, as waveform data, a state quantity of a motor for driving the tool before and after rotation of the tool stops in the tapping;
a reference waveform generation unit configured to generate reference waveform data based on waveform data acquired during first machining by the tool;
a difference waveform calculation unit configured to calculate, as difference waveform data, a difference between waveform data acquired by the data acquisition unit and the reference waveform data;
a waveform feature calculation unit configured to calculate waveform feature data indicating a feature of a waveform from the difference waveform data;
a learning result storage unit configured to store a learning result of learning a correlation between waveform feature data and a time for next tool replacement; and
a state diagnostic unit configured to diagnose a state of the tool based on the waveform feature data using a learning result stored in the learning result storage unit,
wherein the waveform feature calculation unit calculates waveform feature data from data in a section of at least one of a deceleration part before rotation of the motor stops and an acceleration part after rotation of the motor stops in the difference waveform data.

2. The tool diagnostic device according to claim 1, further comprising a learning unit configured to create a learning result of learning a correlation between the waveform data and a time for next tool replacement based on waveform feature data calculated by the waveform feature calculation unit.

3. The tool diagnostic device according to claim 1, wherein a state quantity of the motor is at least one of a speed command value, a torque command, a speed feedback value, and a torque feedback value.

4. The tool diagnostic device according to claim 1, further comprising a user presentation unit configured to present a diagnosis result by the state diagnostic unit to a user.

5. The tool diagnostic device according to claim 2, wherein the learning unit creates, as a learning result, a learning model having learned a correlation between the waveform data and a time for next tool replacement through supervised learning based on waveform feature data calculated by the waveform feature calculation unit.

6. The tool diagnostic device according to claim 1, wherein
the data acquisition unit acquires waveform data from a plurality of industrial machines, and
the state diagnostic unit diagnoses a state of each tool of the plurality of industrial machines.
